(19) United States
(12) Patent Application Publication
(10) Pub. No.: US 2012/0280423 A1
(43) Pub. Date: Nov. 8, 2012

(54) RECYCLING COMPOUND TUBE MEMBER FABRICATION METHOD

(76) Inventor: WINDSOR CHOU, TAIPEI CITY (TW)

(21) Appl. No.: 13/100,380

(22) Filed: May 4, 2011

(51) Int. Cl. B29D 23/00; B29C 65/18

(52) U.S. Cl. 264/257

(57) ABSTRACT

A recycling compound tube member fabrication method includes the steps of a) covering a core tube member with a strippable layer; b) wrapping a glass fiber cloth about the strippable layer; c) putting the core tube member with the wrapped glass fiber cloth in the cavity of a hot press mold and evenly covering the glass fiber cloth with a thermoplastic material in the cavity of the hot press; d) closing the hot press mold and heating the hot press mold to fuse the thermoplastic material and the glass fiber cloth; and e) cooling down the hot press mold and then removing the molded tube member from the hot press mold and removing the core tube member from the molded tube member.

### BACKGROUND OF THE INVENTION

1. Field of the Invention

The present invention relates to a compound tube member fabrication technology and more particularly, to a recycling compound tube member fabrication method, which is practical for the fabrication of a tube member having the characteristics of high structural strength, light weight and recyclability that is suitable for making a golf club, ski stick, tennis racket or bicycle frame.

2. Description of the Related Art

Carbon fiber or carbonized fiber is a plastic reinforced by a graphite textile. It is known alternatively as carbon fiber reinforced plastic or carbon fiber composite. It has a fantastic weight-to-strength ratio. For the advantages of light weight, high strength and high stiffness, carbon fiber is employed in many fields, such as motor vehicles, boats, bicycle frames, golf club shafts, fishing rods, automobile springs, and many other components where light weight and high strength are needed.

Further, carbon fiber is a very strong filament made by the pyrolysis of an organic precursor fiber, such as PAN, rayon or pitch, in an inert environment at a high temperature. However, carbon fiber is very expensive. Attempts to put carbon fiber into mass production have so far failed, due to inadequate demand, the customized nature of most carbon fiber parts, and a lack of skilled craftsmen. Further, regular carbon fiber products are not recyclable. The rise of environment movement in the present era does not favor the application of a material that is not eco-friendly.

### SUMMARY OF THE INVENTION

The present invention has been accomplished under the circumstances in view. It is one object of the present invention to provide a recycling compound tube member fabrication method, which is practical for the fabrication of a tube member having the characteristics of high structural strength, light weight and recyclability that is suitable for making a golf club, ski stick, tennis racket or bicycle frame.

To achieve this and other objects of the present invention, recycling compound tube member fabrication method includes the steps of a) covering a core tube member with a strippable layer; b) wrapping a glass fiber cloth about the strippable layer; c) putting the core tube member with the wrapped glass fiber cloth in the cavity of a hot press mold and evenly covering the glass fiber cloth with a thermoplastic material in the cavity of the hot press; d) closing the hot press mold and heating the hot press mold to fuse the thermoplastic material and the glass fiber cloth; and e) cooling down the hot press mold and then removing the molded tube member from the hot press mold and removing the core tube member from the molded tube member.

Further, the thermoplastic material is selected from the material group of polyethylene, polypropylene, polystyrene, acrylonitrile butadiene styrene, polyethylene terephthalate, acrylic, thermoplastic polyurethane and nylon.

### BRIEF DESCRIPTION OF THE DRAWINGS

FIG. 1 is a schematic drawing illustrating a strippable layer covered on the surface of a core tube member during the fabrication of a recycling compound tube member in accordance with the present invention.

FIG. 2 corresponds to FIG. 1, illustrating a glass fiber cloth wrapped about the strippable layer.

FIG. 3 corresponds to FIG. 2, illustrating the core tube member with the glass fiber cloth put in a hot press mold.

FIG. 4 corresponds to FIG. 3, illustrating the molded tube member removed from the hot press mold and the core tube member removed from the molded tube member.

FIG. 5 illustrates a golf club constructed according to the present invention.

FIG. 6 illustrates a skit stick constructed according to the present invention.

FIG. 7 is a schematic drawing illustrating a strippable layer covered on the surface of a racket-shaped core tube member and a glass fiber cloth wrapped about the strippable layer during the fabrication of a recycling compound tube member in accordance with the present invention.

FIG. 8 is a sectional view in an enlarged scale of a part of FIG. 7.

FIG. 9 illustrates the glass fiber cloth-wrapped racket-shaped core tube member put with pieces of thermoplastic cloth in the cavity of a hot press mold.

FIG. 10 is a sectional side view of FIG. 9.

FIG. 11 corresponds to FIG. 10, illustrating the hot press mold closed.

FIG. 12 is a schematic drawing illustrating a tennis racket constructed according to the present invention.

### DETAILED DESCRIPTION OF THE PREFERRED EMBODIMENT

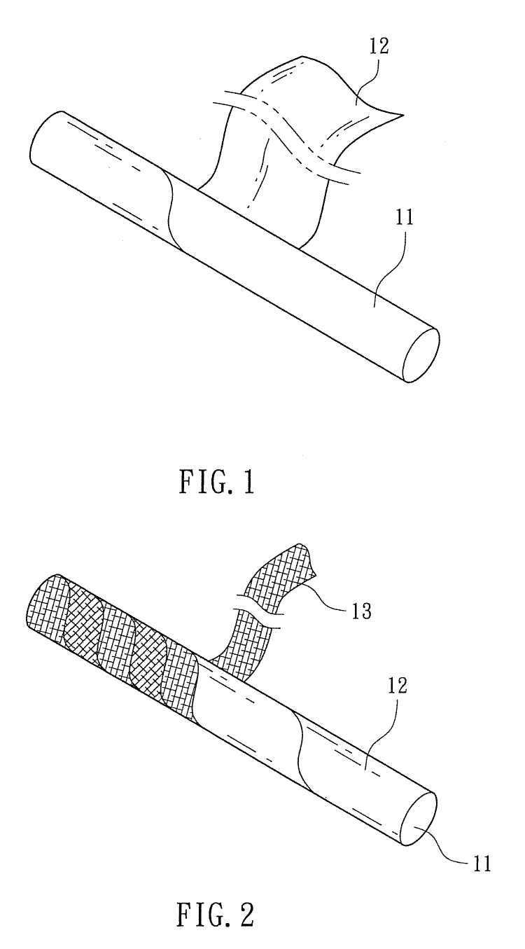

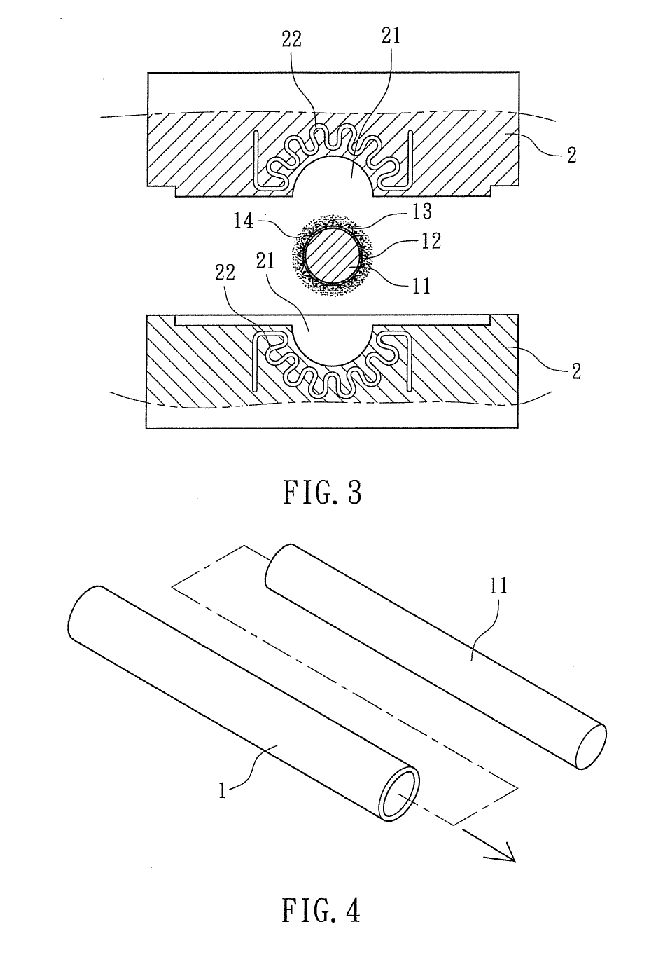

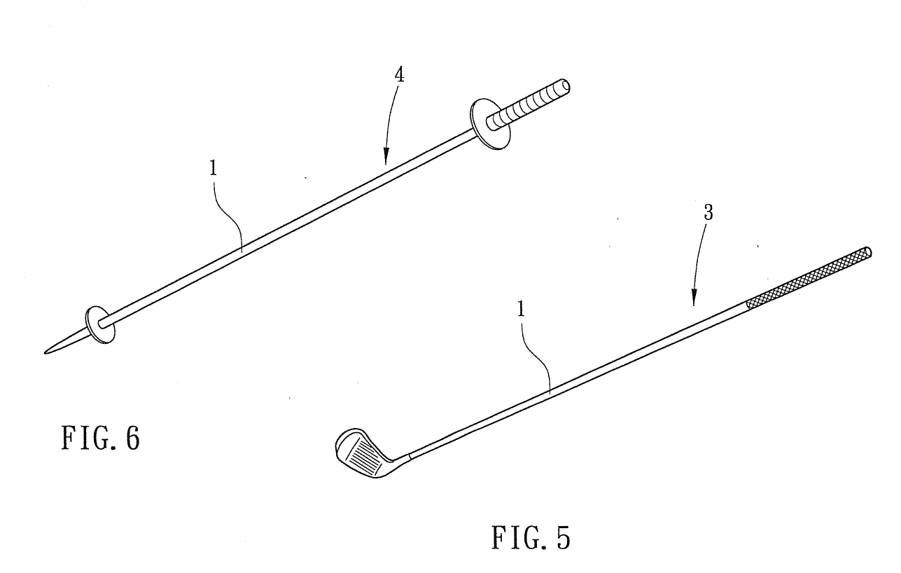

Referring to FIGS. 1˜4, a recycling compound tube member fabrication method in accordance with the present invention is shown comprising the steps of: a) preparing a core tube member 11 and then covering or coating a strippable layer 12 on the surface of the core tube member 11; b) wrapping a glass fiber cloth 13 about the strippable layer 12; c) putting the glass fiber cloth-wrapped core tube member 11 in the cavity 21 of a hot press mold 2 that has mounted therein heating elements 22 and evenly adding thermoplastic material grains (resin) 14 to the surface of the glass fiber cloth 13; d) closing the upper and bottom dies of the hot press mold 2 and starting the heating elements 22 to heat the hot press mold 2 to about 180˜230° C. for about 15˜20 minutes and to further fuse the thermoplastic material grains (resin) 14 and the glass fiber cloth 13; e) turning off the heating elements 22 and cooling down the hot press mold 2 and then removing the molded tube member 1 from the hot press mold 2 and removing the core tube member 11 from the molded tube member 1. The molded tube member 1 has the characteristics of high structural strength, light weight and recyclability, therefore it is suitable for making a golf club 3 (see FIG. 5), ski stick 4 (see FIG. 6) or bicycle frame (not shown). Alternatively, the recycling compound tube member fabrication method can be performed by means of feeding thermoplastic material grains (resin) 14 in a molten state into the cavity 21 of the hot press mold 2 during the heating operation of the heating elements 22.

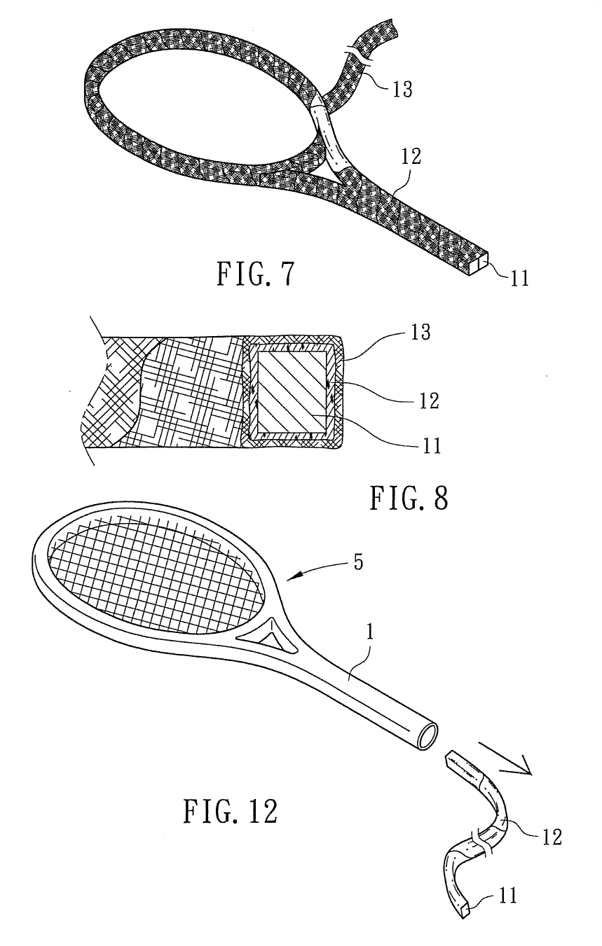

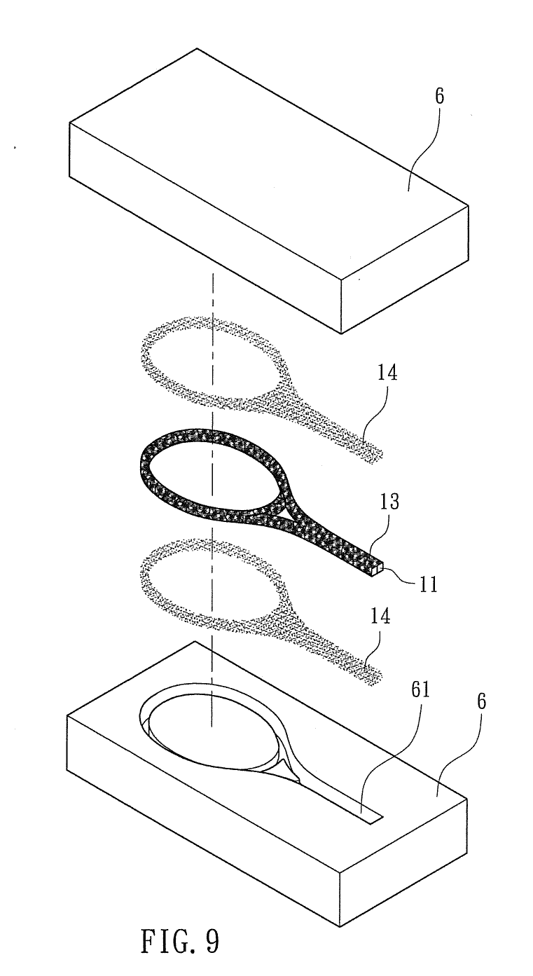

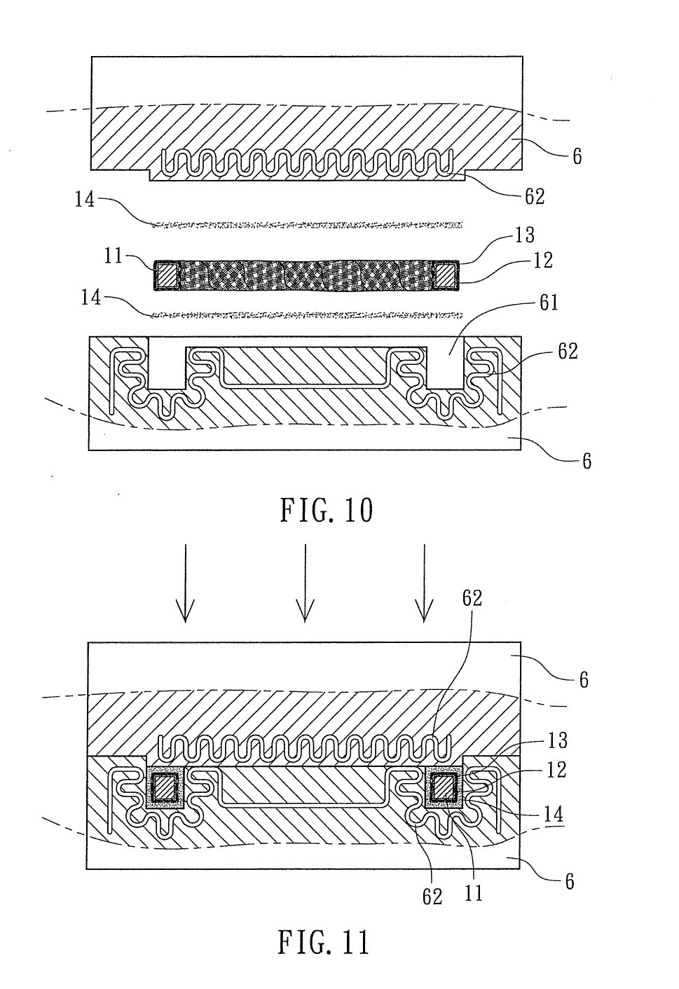

Referring to FIGS. 7˜12, in another alternate form of the present invention for use in the fabrication of a tennis racket 5, the recycling compound tube member fabrication method is as follows: prepare a core tube member 11 configured subject to the shape of the desired tennis racket 5 and then cover or coat a strippable layer 12 on the surface of the core tube member 11, and then wrap a glass fiber cloth 13 about the strippable layer 12, and then put the glass fiber cloth-wrapped core tube member 11 in the cavity 61 of a hot press mold 6 that has mounted therein heating elements 62, and then evenly add thermoplastic material grains (resin) 14 to the surface of the glass fiber cloth 13 in the cavity 61 of the hot press mold 6, and then close the upper and bottom dies of the hot press mold 6 and turn on the heating elements 62 to heat the hot press mold 6 to about 180˜230° C. for about 15˜20 minutes to fuse the thermoplastic material grains (resin) 14 and the glass fiber cloth 13, and then turn off the heating elements 62 and cool down the hot press mold 6 and then remove the molded tube member 1 from the hot press mold 6 and removing the core tube member 11 from the molded tube member 1.

Further, thermoplastic cloth, thermoplastic fibers may be used to substitute for the thermoplastic material grains (resin) 14. The thermoplastic cloth, thermoplastic fibers and thermoplastic material grains (resin) 14 can be selected from the material group of polyethylene, polypropylene, polystyrene, acrylonitrile butadiene styrene, polyethylene terephthalate, acrylic, thermoplastic polyurethane and nylon.

Further, in another alternate form of the present invention, the recycling compound tube member fabrication method comprises the steps of a) preparing a core tube member 11 and then covering or coating a strippable layer 12 on the surface of the core tube member 11; b) wrapping a woven fabric of thermoplastic fibers and glass fibers may about the core tube member 11; c) putting the woven fabric-wrapped core tube member 11 in the cavity 21(61) of a hot press mold 2(6) that has mounted therein heating elements 22(62); d) closing the upper and bottom dies of the hot press mold 2(6) and starting the heating elements 22(62) to heat the hot press mold 2(6) to about 180˜230° C. for about 15˜20 minutes and to further fuse the thermoplastic fibers and glass fibers of the woven fabric; e) turning off the heating elements 22(62) and cooling down the hot press mold 2(6) and then removing the molded tube member 1 from the hot press mold 2(6) and removing the core tube member 11 from the molded tube member 1.

In either of the aforesaid various embodiments of the present invention, the cross section of the core tube member 11 can be configured subject to any of a variety of shapes.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A recycling compound tube member fabrication method, comprising the steps of:
a) preparing a core tube member and then covering the periphery of said core tube member with a strippable layer;
b) wrapping a glass fiber cloth about said strippable layer;
c) putting said core tube member with the wrapped glass fiber cloth in a cavity of a hot press mold having mounted therein a plurality of heating elements and evenly covering said glass fiber cloth with a thermoplastic material in the cavity of said hot press;
d) closing said hot press mold and applying a pressure to said hot press and turning on said heating elements to heat said hot press mold and to further fuse said thermoplastic material and said glass fiber cloth; and
e) turning off said heating elements and cooling down said hot press mold and then removing the molded tube member from said hot press mold and removing said core tube member from the molded tube member.

2. The recycling compound tube member fabrication method as claimed in claim 1, wherein said heating elements are turned on to heat said hot press mold to about 180˜230° C. for about 15˜20 minutes during step.

3. The recycling compound tube member fabrication method as claimed in claim 1, wherein said thermoplastic material is fed into said cavity of said hot press mold in a molten state during step.

4. The recycling compound tube member fabrication method as claimed in claim 1, wherein said thermoplastic material is selected from the material group of thermoplastic resin, thermoplastic cloth and thermoplastic fibers.

5. The recycling compound tube member fabrication method as claimed in claim 1, wherein said thermoplastic material is selected from the material group of polyethylene, polypropylene, polystyrene, acrylonitrile butadiene styrene, polyethylene terephthalate, acrylic, thermoplastic polyurethane and nylon.

6. The recycling compound tube member fabrication method as claimed in claim 1, wherein said core tube member has a cross section configured subject to a predetermined shape.

7. A recycling compound tube member fabrication method, comprising the steps of:
a) preparing a core tube member and then covering the periphery of said core tube member with a strippable layer;
b) preparing a woven fabric by using thermoplastic fibers and glass fibers and then wrapping said woven fabric about said strippable layer;
c) putting said core tube member with said strippable layer and said woven fabric in a cavity of a hot press mold having mounted therein a plurality of heating elements;
d) closing said hot press mold and applying a pressure to said hot press and turning on said heating elements to heat said hot press mold and to further fuse the thermoplastic fibers and glass fibers of said woven fabric; and
e) turning off said heating elements and cooling down said hot press mold and then removing the molded tube member from said hot press mold and removing said core tube member from the molded tube member.

8. A recycling compound tube member fabrication method, comprising the steps of:
a) preparing a core tube member and then covering the periphery of said core tube member with a strippable layer;
b) putting said core tube member with said strippable layer in a cavity of a hot press mold having mounted therein a plurality of heating elements;
c) melting a thermoplastic material and glass fiber material;
d) closing said hot press mold and feeding the melted thermoplastic material and the melted glass fiber material into the cavity of said hot press and then applying a pressure to said hot press and turning on said heating elements to heat said hot press mold; and
e) turning off said heating elements and cooling down said hot press mold and then removing the molded tube member from said hot press mold and removing said core tube member from the molded tube member.

9. The recycling compound tube member fabrication method as claimed in claim 7, wherein said thermoplastic material is selected from the material group of polyethylene, polypropylene, polystyrene, acrylonitrile butadiene styrene, polyethylene terephthalate, acrylic, thermoplastic polyurethane and nylon.

10. The recycling compound tube member fabrication method as claimed in claim 7, wherein said heating elements are turned on to heat said hot press mold to about 180˜230° C. for about 15˜20 minutes during step.
